(19) United States
(12) Patent Application Publication
(10) Pub. No.: US 2007/0266422 A1
(43) Pub. Date: Nov. 15, 2007

(54) Centralized Dynamic Security Control for a Mobile Device Network

(76) Inventors: Vernon P. Germano, Wentzville, MO (US); Jeff Ayers, Chesterfield, MO (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/555,535

(22) Filed: Nov. 1, 2006

Related U.S. Application Data
(63) Continuation-in-part of application No. 11/381,291, filed on May 2, 2006.
(60) Provisional application No. 60/732,380, filed on Nov. 1, 2005.
(60) Provisional application No. 60/732,253, filed on Nov. 1, 2005.
(60) Provisional application No. 60/732,254, filed on Nov. 1, 2005.

(51) Int. Cl. H04L 9/00

(52) U.S. Cl. 726/1

(57) ABSTRACT

An security system for an enterprise network and data automates the revision, deployment, enforcement, auditing and control of security policies on mobile devices connected to said enterprise network, through automated communication between a security policy server and the mobile device. Control of the security system is centralized through administrative control of security policies stored on the security policy server. Automation of deployment of security policies to mobile devices occurs through transparent background communication and transfer of updated policies either triggered by a change in a security policy within the central repository of security policies or upon the expiration of a certain time period during which no policies were downloaded to the mobile device. When the mobile device is not in compliance with a security policy, a software security agent operating thereon limits access to said enterprise network and enterprise data. To aid in preventing the overwhelming of the enterprise network and the security policy server as a result of to many synchronization communications coming from too many mobile devices, a randomized timer is set by the software security agent upon receipt by the mobile device of a synchronization command from the security policy server.

### CROSS REFERENCE TO RELATED APPLICATIONS

This application claims priority to and the benefit of U.S. Provisional Patent Applications No. 60/732,380, 60/732,253, and 60/732,254, each of which were filed Nov. 1, 2005, and is a continuation-in-part of and claims priority to US Utility Application No. 11/381,291, filed May 2, 2006. Each of the prior referenced documents is incorporated herein in its entirety by this reference.

### BACKGROUND OF THE INVENTION

1. Field of the Invention

The invention relates to an electronic security system for the protection of enterprise network usage and enterprise data stored on the enterprise network; and more particularly to a system in which a security policy relevant to a mobile device can be centrally managed from a policy server and automatically transmitted to the mobile device.

2. Description of Related Art

The technology world is a constantly changing environment, with computers gaining power while at the same time continually becoming smaller. Of course these are not the only aspects that change as the digital wizards constantly create new ways to “simplify” our lives with completely new devices to connect us to an increasingly wired and wireless world. Today, laptops, PDAs, and Smart Phones are standard equipment for the mobile corporate environment.

The basic premise of a mobile computing device (“mobile device”) is to either enhance one's working capabilities, or to add convenience with the ultimate goal of increasing productivity. Applications are written for mobile devices allowing them to provide basic, and in many cases complete, functionality when compared to using a desktop computer in the office. Mobile devices are able to store, or at least access, an organization's information. This access requires the implementation of “mobile data security”, i.e., security for data accessible through mobile devices.

Today's mobile devices are powerful computing platforms, capable of storing tremendous amounts of valuable assets, including financial spreadsheets, presentations, employee/customer/patient information, intellectual property, etc., which can create serious security risks to the enterprise to which such information belongs or has been entrusted.

Every year more mobile devices are issued to employees and the percentage of hardware thefts increases respectively. However, the value of the information stolen from those lost devices far exceeds that of the hardware.

Organizational computer security has traditionally revolved around the concept of a secured perimeter. The idea is to build an impenetrable fence or wall around the organization's internal network and all its data. Traditional security efforts therefore have been focused on enforcing this network boundary security with products such as firewalls, virtual private networks, and anti-virus software. While these safeguards are critical to any computer system, mobile or stationary, this is not the full scope of security necessary for protection.

The difficulty with security for mobile and wireless devices is that they do not generally reside within the enterprise's primary security installations. Historically, an enterprise has relied in significant part upon the physical isolation of its computing network and its data, and its ability to limit physical access to such an isolated network and data. In particular for mobile devices, however, data is carried outside of the physical boundaries of the enterprise property on mobile devices carried anywhere persons travel, and enterprise network access is gained through network connections that travel through electronic nodes controlled other than by the enterprise. For these reasons, security of data stored on a mobile device and security of data communicated between a mobile device and an enterprise is challenging.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description that is presented later.

A network security system as herein described includes a system and methods for delivering security policies in real time to mobile devices from a security policy server using over-the-air techniques.

In an embodiment, the security system is for use in aiding in the exclusion of unauthorized access to an enterprise network or enterprise data. In such an embodiment, the system comprises a mobile device on which operates a software security agent that monitors compliance of the mobile device with at least one security policy; a security policy server on which is stored the at least one security policy applicable to the mobile device and through use of which the at least one security policy can be modified; an enterprise network or enterprise data accessible by the mobile device only through communication with the security policy server; and a network connected to but external to the enterprise network, through which the mobile device can transmit data to and receive data from the security policy server. In an embodiment, the at least one security policy comprises data correlated to a hardware or software configuration or both a hardware and software configuration of the mobile device. In an embodiment, the network connected to but external to the enterprise network includes a communication pathway that includes a wireless communication connection.

In an alternate embodiment the security is provided by a method for automated centralized control of security features of an enterprise communication network or of enterprise data. In an embodiment, the method comprises the steps of providing a security system such as that described above; providing the mobile device with an initial configuration compliant with an initial security policy; connecting the mobile device to the security policy server without mobile device user participation; downloading a revised security policy from the security policy server to the mobile device. In an embodiment, the step of connecting is triggered by a lapse of a pre-set amount of time after a prior execution of the step of downloading. In an embodiment, the step of connecting is triggered by a change in the security policy stored on the security policy server.

### BRIEF DESCRIPTION OF THE DRAWINGS

FIG. 1 illustrates a schematic of a network system as an embodiment of the security system.

### DETAILED DESCRIPTION OF PREFERRED EMBODIMENTS

The network security system and methods described herein are generally designed to protect enterprise data, and those persons accessing it with authorization, from the unwarranted and malicious access, including access by unauthorized users, such as when a mobile device is lost or stolen, and damaging software like worms and viruses. The security system provides for self-service and automated administration, including policy enforcement and reporting.

The security system includes a variety of features. It provides delivery to end-user devices of security policy updates automatically without user intervention, including over the air for wireless devices, and does so for a variety of hardware configurations and a variety of operating system. It provides centralized security policy management across heterogeneous devices from a single self-service console. It allows delegation of administration for end users. It provides complete installation and management of security policies and applications on end-user devices, including over the air for wireless devices. It monitors security policy compliance for local and remotely deployed systems and provides remediation of the non-compliant devices automatically, enabling an organization's conformity with regulatory requirements. The security system can be enhanced with full-device encryption, i.e., encryption for all data stored on a device, for each device authorized to access the enterprise information via the controlled network.

As used herein, the term mobile devices means any device that a reasonable person uses for mobile data communications and for which the functionality thereof can be altered through software programming. Such mobile devices may also be referred to as Smart Phones or Personal Digital Assistant (“PDAs”), and further include portable and laptop computers, but regardless of the name, the mobile device software will allow the mobile device access to the Internet or will allow email communication.

As used herein, the term over-the-air (“OTA”) means a communication pathway between a two devices connected by a network, e.g., a server and a mobile device, wherein a portion of the pathway is wireless communication, i.e., data transmitted from one antennae to another antennae through the air via electromagnetic waves, such as the over-the-air communication that occurs from a cellular phone to a cell tower.

As used herein in broad scope, the term security policy refers to a dataset that correlates to a hardware or software configuration on a networked device. Generally, a mobile device will be configured to conform with a policy, and such configuration will be maintained or otherwise enforced by a software security agent operating on the mobile device so configured. Thus, a portion of the security system herein disclosed operates to ensure that a certain security policy has a common definition as between the security policy server, where policy definition is controlled and maintained by a system administrator, and on the mobile device. For example, for a policy that requires firewall port blocking with regard to a specific port, a software security agent operating on the mobile device will operate to prohibit communication through such port, thereby enforcing the requirement of the policy. The security policies are centrally controlled.

The security system is effective across various mobile device platforms (i.e., the various hardware and software configurations of mobile devices, and particularly the various operating systems operating various mobile devices) because the centralized policies are segmented into groups of policies, each group of policies being applicable to one or more mobile device platforms. In an embodiment, only security policies applicable to a mobile device, as based upon the mobile device platform, are synchronized as between the security policy server and the mobile device. In an embodiment, security policies that the security policy server attempts to communicate to a mobile device, but which are inapplicable to the particular mobile device due to the mobile device's platform, are rejected by the mobile device or are accepted and ignored or deleted by the mobile device, which communicates that inapplicability of the policy back to the security policy server.

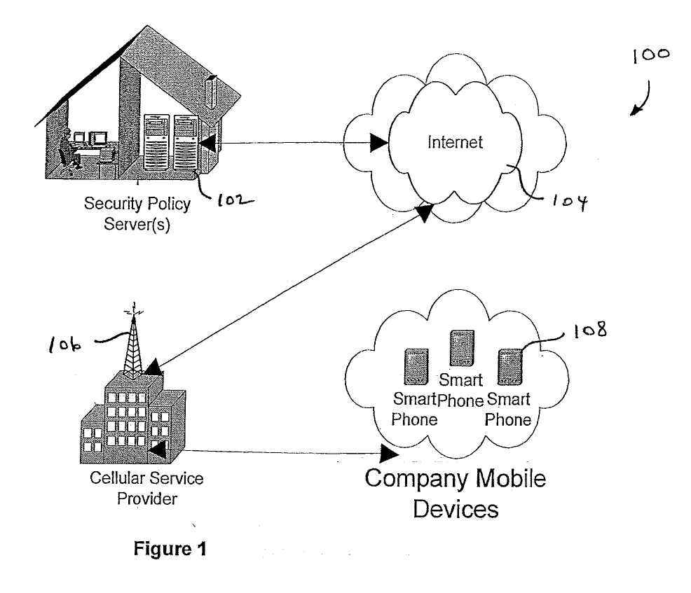

FIG. 1 illustrates an exemplary OTA hardware architecture that an organization may employ in order to deliver security policies to mobile devices. In general, the security system herein disclosed is operable within such architecture to provide platform-independent security for controlling access to data stored on the at least one server computer 102, or on computers connected thereto, such as on a private enterprise network. Security policies intended to be utilized by a mobile device 108 are stored on a security policy server 102, and synchronized with a mobile device 108. The mobile device 108 is allowed to access enterprise data not stored on the mobile device only if the mobile device 108 operates in compliance with the security policies provided by and stored on the security policy server 102. Such compliance is automatically verified through communications between the mobile device 108 and the security policy server 102 whenever the mobile device 108 attempts to connect to the enterprise network or access enterprise data either stored on the at least one security policy server 102 or on a computer networked thereto, and is verified at regular time intervals while the mobile device 108 is connected to the security policy server 102 or otherwise connected to the enterprise network.

Such verification is accomplished through a security policy synchronization process, as is described herein. Descriptions of the communications between a networked server and a mobile device such as can be utilized for the purpose of such synchronization are provided in U.S. Patent Publication No. 2006/0224742, published Oct. 5, 2006, which is incorporated herein in its entirety by this reference. A compliant status for the mobile device preferably includes an approved hardware and software structure and configuration, and approved functionality, status, and activity.

In an embodiment, at least one security policy server 102 which is part of an enterprise network is provided with access to the Internet 104, whether such connection is wired or wireless. The security policy server 102 communicates with authorized cell phones 108 (mobile devices) by sending and receiving OTA data to and from such cell phones through the Internet 104 and a cellular service cell tower 106. The illustrated system including the policy server 102, the Internet 104, cell tower 106, and cell phones 108 is generally referred to as a networked environment 100, wherein exchange of data and sharing of network resources is allowed between and among computing devices and their users when each is properly authenticated. Communication, i.e., the sharing of data, occurs over the networked environment through exchange of data packets, which are discrete groups of electronic signals encoded according to standard protocols so as to be recognizable by various components, i.e., computing devices, of the network environment 100. Such communication over a networked environment via protocol compliant data packets is described in U.S. Patent Publications No. 2006/0179140 and 2006/0179141, each published on Aug. 10, 2006, and U.S. Patent Publication No. 2006/0236370, published on Oct. 19, 2006, each of which is incorporated by reference herein.

In an embodiment of the security system, OTA communication allows an exchange of security data between a mobile device 108 and a security policy server 102. In an embodiment, the exchange of OTA data is initiated either when a security policy is changed on the security policy server 102 or when a threshold amount of time has expired without a download of a security policy to the mobile device 108 from the security policy server 102, triggering a software security agent operating on a mobile device 108 to initiate download of one or more security polices from the security policy server 102.

In an embodiment, when a security policy is changed, such as by an authorized administrator, the security policy server 102 formats a predetermined message and sends the message to all affected mobile devices 108. The software security agent operating on a mobile device 108 receiving such message receives the message and responds accordingly by taking the action directed by the message. In an embodiment, the action taken will be for the software security agent to initiate communication to the security policy server 102, such communication directing the transfer of the changed security policy from the security policy server 102 to the mobile device 108.

In an embodiment, as monitored by the software security agent operating on a mobile device 108, after a pre-set amount of time has past since the last download of a security policy to that mobile device 108, the software security agent sends a message to the security policy server 102 directing transfer of one or more security policies. In an embodiment, the message from the mobile device 108 directs transfer of only those security policies that have changed since the last time that mobile device 108 downloaded security policies. In an embodiment, the message from the mobile device 108 directs the transfer of all security policies relevant to that mobile device 108, including those security policies that have changed as well as those security policies that have not changed since the last download of a security policy by this mobile device 108. This time-triggered download of security policies may be particularly important in situations when a mobile device 108, for whatever reason, such as due to hardware or software failure, did not receive the last message sent by the security policy server 102 upon a change in a security policy relevant to that mobile device 108.

In a preferred embodiment, data transmitted between the software security agent operating on the mobile device 108 and the security policy server 102 is encrypted. Such encryption is likely to prevent unwanted access to the message structure of the messages. Unauthorized access to such message structure could allow a loss of integrity to enterprise data, for instance, if a security policy was altered by a person or machine gaining unauthorized access to such message structure and thereby allowing uncontrolled and unauthorized access to the mobile device 108 and the data stored thereon.

In an embodiment, security policy compliance requires the mobile device 108 comprise at least one of an authorized device serial number, device ESN, device manufacturer, device model name, device operating system (OS) or OS version, device ROM version, device peripherals list, device total memory, device free memory, application list and versions, applications currently running, registry setting snapshot (for relevant devices), date and time of most recent reset or policy update or OTA or USB synchronization, policy number, network interface list and configuration, network connections, geographical location, user name or user ID or user group of current user, or combinations thereof.

In an embodiments, a security policy includes but is not limited to a policy that ensures that a mobile devices has communicated to the security policy server in a given period of time. In an alternate embodiment, a security policy may contain values dictating the objects that must be available on a mobile device, such as one or more software programs, data files, or other objects that may be stored in the mobile device's file systems, data storage areas, or other volatile or non-volatile storage media associated with the remote device.

Security policy enforcement is via a management agent software application that exists on the mobile device, a software security agent. The purpose of the management agent is to maintain the device's integrity by ensuring that security policy is up to date and is enforced through methods such as authentication, encryption, and port control.

In an embodiment, the security system includes a process termed Security Policy Based Network Access and Network Compliance Control (SNANC), which ensures that a mobile device is restricted from access to all but specific network resources when a device is out of compliance with published security policy.

SNANC consists of a centralized management server, a synchronization infrastructure to implement sharing of security policy and a remote device enforcement agent. In an embodiment, SNANC works as follows:

A security policy server is configured with a set of security policies that are synchronized onto a mobile device, as described above.

The set of security policies includes a limited access security policy that requires the mobile device to use a specific network route for network communication when the mobile device is non-compliant with a certain one or more of the other security policies applicable to the mobile device.

When a violation of the certain one or more security policies is detected by the enforcement agent software running in the background on the mobile device, network communications to and from the mobile device will be limited by the enforcement agent to the network route specified by the limited access security policy. In this regard, all external communications packets are checked to identify the sending or receiving port ID and address, and only those communications incorporating the specified identifications for recipient or sender will be allowed to pass through to the mobile device from the networked environment or to pass out to the networked environment from the mobile device.

The mobile device enforcement agent will continue to limit access to network resources to those identified within the limited access security policy, until such a time as either: (a) the security policies change, the changed policies are synchronized with the mobile device, and the enforcement agent is able to verify that the mobile device is in compliance with the security policy set applicable to that mobile device; or (b) the mobile device comes into compliance via user action or via the implementation of self-corrective measures, such as automated restoration of deleted files or other configuration changes. When the mobile device is again determined to be in compliance with the security policy set, the limitation of specific network routing is removed and the device is allowed to connect to other network resources.

In an embodiment, the specified network communication routing in the limited access security policy allows communication between the mobile device and the security policy server for various purposes including security policy synchronization, software installation, data manipulation, password recovery, and log message handling.

In an embodiment, the security system operates to block access to data stored on an enterprise network by blocking access by the mobile device 108 to the enterprise network altogether, or by restricting such enterprise network access to a remediation server. In an embodiment, software running on such a remediation server can direct communication to the mobile device 108, which includes instructions that, when followed by the software security agent operating on the mobile device 108, corrects the non-compliant configuration of the mobile device 108. In an embodiment, if the mobile device cannot be made compliant through interaction with the remediation server, enterprise network access by the mobile device is blocked until a network administrator can reconfigure the mobile device 108 so as to be compliant with the applicable security policy set.

Through such a process, of communication between the mobile device 108 and the security policy server 102, with consequent communication between the mobile device 108 and a remediation server, if necessary, the security system provides automated enforcement of the security policies relevant to each mobile device 108 in communication with the enterprise network. Preferably, these functions of the security system can operate transparently to the user of the mobile device 108. By operating in the background of the user-directed operations of the mobile device 108, the user of the mobile device 108 only becomes directly aware of the operation of the security system when certain problems arise, such as denial of access to the enterprise data through the enterprise network.

A further aspect of the security system herein disclosed relates to the scheduling of the synchronization processes for the multiple mobile devices having authorization to access the enterprise network and its data, and particularly those mobile devices for which security policy control is exercised by the security policy server. Because the number of mobile devices controlled by the security policy server may be so great that simultaneous synchronization of security policies for each mobile device would have a significant negative impact on network function, and may even disable the network. Therefore, the security system herein disclosed includes, in an embodiment, a Bi-Directional Collision Protection and Synchronization Scheduling (BCPSS) module, which addresses the problem of overwhelmed centralized systems, such as the security policy server, by limiting the number of simultaneous pull synchronization transactions requested by mobile devices and processed by the security policy server at one time.

In an embodiment of the BCPSS module, a remote device's software security agent queues the processing of a command from the security policy server for a random period of time within a pre-determined range. The time based range may be determined by security system administrators, and, for instance, be incorporated into a security policy synchronized between the mobile device and the security policy server, or may be built into the security system by the system architect. The randomizing of the queue wait time, i.e., the time that the command remains in a queue on the mobile device prior to being processed by the mobile device results in various times between the issuance of the command by the security policy server and the response to the command (as through communication from the mobile device to the security policy server) by the various mobile devices controlled by the security policy server.

In an embodiment, this queue wait time variation among mobile devices ensures that not all or even most of the mobile devices controlled by the security policy server will simultaneously respond to the command with communications to the security policy server, and thereby avoids a overwhelming the security policy server with incoming communications. Generally, the larger the range of time allowed to the mobile device's software security agent for setting the randomized queue wait time, the greater the chance that fewer mobile devices will initiate sessions simultaneously for synchronization with the security policy server. Thus, the BCPSS module can be used to reduce enterprise network bandwidth requirements, enterprise network latency, and security policy server simultaneous connections.

In an embodiment, another benefit of the BCPSS module is provided to the mobile device on which it is implemented, in that frequent incoming synchronization commands do not result in the mobile device initiating synchronize action multiple times, but only after a period of delay that ensures that command messaging from the security policy server has completed.

As an example, a method for implementing a BCPSS-based synchronization process is a follows:

Remote devices are configured to run a software security agent that listens for incoming synchronization commands from the security policy server. These incoming commands may take several forms including but not limited to Short Message Service (SMS) based messages, e-mail, and other methods that may contain command payloads. SMS using encrypted XML message payloads is one basic example of an implementation for sending commands to the software security agent running on the mobile device. Other implementations may use socket based listeners or other standard methods for signaling the mobile device.

A security policy server pushes properly formatted command messages to an address list of all configured remote devices. These messages may be triggered by time based events or may occur whenever a change to a specific data element occurs in the security policy server. As discussed above, wherein a policy is applicable to various mobile device platforms, commands to revise that policy may be formatted differently to accommodate the various platforms.

Mobile devices operating the software security agent receive the security policy server commands, unwrap the command message payload via decryption, cyclic redundancy check (CRC), or through the implementation of other techniques for ensuring the command is properly formatted and meets all of the system security requirements.

The mobile device software security agent determines whether to reset a randomization timer and queue the command to be processed at the end of the time set on the timer, or, in the case of commands that should not be queued, the software security agent clears the queue timer and the command is immediately processed.

Should an incoming command message be received by the mobile device before the queue timer has expired for a prior command message, the queue timer is cleared and is reset to a randomized time value. This reset feature ensures that incoming synchronization commands will only be processed in a configurable time range and that successive commands sent to the mobile device from the security policy server will not result in the mobile device repeatedly or continually synchronizing with the security policy server.

In addition to the above disclosure, current versions of the following guide documents produced for Mobile Armor, LLC to support commercial embodiments of a security system as herein described, are incorporated by reference: PolicyServer v3.0 for Managed Services Providers—Sprint Edition, Administrator Guide; PolicyServer v3.0 for Managed Services Providers—Sprint Edition, Administrator Guide Appendices; MobileSentinel v3.0 for Managed Services Providers—Sprint Edition, Administrator Guide; DataArmor v3.0 for Managed Services Providers—Sprint Edition, Administrator Guide; FileArmor v2.2.5 for MSPs—Sprint Edition, Administrator/User Guide; VirusDefense v3.0 for Managed Services Providers—Sprint Edition, Administrator Guide; RemoteNetwork v3.0 for Managed Services Providers—Sprint Edition, Administrator Guide; MobileFirewall v3.0 for Managed Services Providers—Sprint Edition, Administrator Guide.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A security system for use in aiding in the exclusion of unauthorized access to an enterprise network or to enterprise data, said system comprising:
a mobile device on which operates a software security agent that monitors compliance of said mobile device with at least one security policy and limits access of said mobile device to a networked environment when said mobile device is not in compliance with said security policy;
a security policy server on which is stored said at least one security policy applicable to said mobile device;
server management agent software through which said at least one security policy on said security policy server can be modified by an administrator, and which automatically sends a command message over said networked environment to said mobile device upon a change to said security policy; and
wherein upon processing said command message by said software security agent operating on said mobile device said security policy on said mobile device is revised.

2. The security system of claim 1 wherein said at least one security policy comprises data correlated to a hardware or software configuration or both a hardware and software configuration of said mobile device.

3. The security system of claim 1 wherein said mobile device connects to said networked environment through a wireless communication connection.

4. A method for automated centralized control of security features of an enterprise communication network, said method comprising the steps of:
providing a security system comprising:
a mobile device on which operates a software security agent that monitors compliance of said mobile device with at least one security policy;
a security policy server on which is stored said at least one security policy applicable to said mobile device and through use of which said at least one security policy can be modified;
a networked environment through which said mobile device can transmit data to and receive data from said security policy server;
providing said mobile device with an initial configuration compliant with said at least one security policy;
initiating a communication session between said mobile device and said security policy server without mobile device user participation;
downloading a revised security policy from said security policy server to said mobile device.

5. The method of claim 4 wherein said initiating is commenced by said software security agent and triggered by a lapse of a pre-set amount of time after a previously executing said downloading.

6. The method of claim 4 wherein said initiating is commenced by said security policy server sending a command message to said mobile device and is triggered by a change in said security policy stored on said security policy server.
